(19) United States
(12) Patent Application Publication
(10) Pub. No.: US 2007/0174174 A1
(43) Pub. Date: Jul. 26, 2007

(54) Method for indicating current market prices across a range of prices

(76) Inventor: Steven J. Brucato, Naperville, IL (US)

Correspondence Address: MICHAEL P. MAZZA, LLC, 686 CRESCENT BLVD., GLEN ELYN, IL, 60137, US

(21) Appl. No.: 11/336,200

(22) Filed: Jan. 21, 2006

(51) Int. Cl. G06Q 40/00

(52) U.S. Cl. 705/37; 705/36 R

(57) ABSTRACT

A GUI display, method and system facilitating electronic trading. The GUI display presents market scope for a traded instrument, including showing and differentiating the current market from at least one selected historical market. A separately denoted last traded price may also be displayed. Preferably, an order entry tool, including a plurality of bids, offers and aligned price entries for the traded instrument, is aligned with the market scope display. In one preferred embodiment, the graphical display includes histograms color-coded to show ranges of offers and bids, and to separately denote the last traded price.

U.S. Ser. No. ______ filed Dec. 20, 2005 and titled “A Graphical User Interface And Method For Displaying Market Data And Entering Trade Orders” concurrently-filed U.S. Ser. No. ______, titled “Optimized Order Routing For Electronic Trading,” U.S. Ser. No. ______, filed Dec. 6, 2005, titled “Method And System for Detecting And Managing Message Throttle Conditions,” concurrently-filed U.S. Ser. No. ______ filed ______, 2005, titled “A Method For Displaying Market Data And Entering Trading Orders” and concurrently-filed U.S. Ser. No. ______, titled “A Method For Estimating The Time Position Of Queued Electronic Orders,” are hereby incorporated by reference into this application in their entirety.

### BACKGROUND OF THE INVENTION

The present invention generally relates to computerized trading systems. More specifically, the invention relates to a novel method for displaying market data and facilitating the entry of trading orders using specialized graphical user interfaces (GUIs).

As trading of stocks, bonds, and derivatives (futures and options) move ever more into the realm of electronic trading, the display of data and the ability to mentally process this data to make an order-entry decision is important to a trader's success. The ability of a trader to perceive the movement of the inside market across a wide range of prices is also important, as the volatility of some instruments can be very large.

Volatility can be defined as the range between the highest bid (or offer) price of the day and the lower bid (or offer) price of the day. For many heavily traded products, the volatility can be very large and, thus, price movements for a given traded instrument may exceed the typical visible area of a computer display.

Accordingly, it would be advantageous to visually present current and historical market data so that a trader has an immediate grasp of current and historical prices in the market and volumes available at those various price levels. It would also be advantageous to allow traders to view the full range of prices in the market (“market depth”) and track this movement over a wide range of market prices as the market moves.

### SUMMARY OF THE INVENTION

This invention allows for a novel presentation of market data in a visual manner that provides the trader with an immediate sense of “where the market is” by displaying the current inside and outside market, and allowing the trader to view this range across a very wide range of prices. The preferred GUI, known as Market Scope™, allows a trader to view the full range of prices in the market (market depth) and to also track this movement over a wide range of market prices as the market moves.

Accordingly, in a preferred embodiment of the present invention, a GUI display is provided which presents market scope for a traded instrument. This includes a graphical display showing and differentiating the current market from at least one selected historical market for the traded instrument. Preferably, the graphical display separately denotes a last traded price. Also, preferably, an order entry tool is provided which includes a plurality of bids, offers and aligned price entries for the traded instrument, and which is aligned with the market scope. The graphical display may include histograms color-coded to show ranges of offers and bids, and which may also be separately color-coded to display a last traded price.

In another preferred embodiment, a method of electronically trading an instrument is provided, using a GUI display presenting market scope for the traded instrument. In this method, the graphical display shows and differentiates the current market from at least one selected historical market. An order entry tool with a plurality of bids, offers and aligned price entries for the traded instrument is provided and aligned with the graphical display. The order entry tool is used to place a trade order for the traded instrument. As with the earlier embodiment, the graphical display in this method embodiment may separately denote a last traded price, and may include histograms color-coded to show ranges of offers and bids.

In yet another preferred embodiment, a system is provided for placing a trade order for a traded instrument on an electronic exchange having an inside market with a highest bid price and a lowest ask price. The system includes a graphical user interface for displaying market depth of the traded instrument, through a dynamic display of a plurality of bids and a plurality of asks in the market for the traded instrument, which include the bid and ask quantities of the traded instrument, and which is aligned with a display of prices for the traded instrument. An order entry region is displayed, and aligned with the display of prices. The order entry region includes a plurality of areas for receiving commands to send trade orders, with each area corresponding to a price of the display of prices; The graphical user interface also shows and differentiates the current market from at least one selected historical market. A user input device is provided for positioning a pointer over an area in the order entry region. A trade order sending component is included for receiving a command as a result of a selection of the area in the order entry region by a single action of the user input device with a pointer of the user input device positioned over the area, and to set a plurality of additional parameters for the trade order and to send the trade order to the electronic exchange.

### BRIEF DESCRIPTION OF THE DRAWINGS

The novel features which are characteristic of the invention are set forth in the appended claims. The invention itself, however, together with further objects and attendant advantages thereof, can be better understood by reference to the following description taken in connection with the accompanying drawings, in which:

FIG. 1 shows a basic graphical user interface, known as Market Scope™, that displays historical and current market data, including the range of offers and bids, and the last traded price, using histograms;

FIG. 2 shows an alternate user interface for Market Scope™ using a single bar to show current (e.g., a solid tri-colored bar) and past (e.g., a semi-transparent tri-colored bar) market conditions; and

FIG. 3 shows a particularly preferred embodiment in which Market Scope™ is used with a detailed view of the market, such as an order entry tool like Rotator™, the subject of concurrently-filed U.S. Ser. No. ______, titled “A Graphical User Interface And Method For Displaying Market Data And Entering Trade Orders” (“the Rotator™ patent”).

The components in the drawings are not necessarily to scale, emphasis instead being placed upon clearly illustrating the principles of the present invention. In the drawings, like reference numerals designate corresponding parts throughout the several views.

### DEFINITION OF CLAIM TERMS

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Current market” means the current inside market and the current outside market for a given traded instrument.

“Inside market” means the highest bid price and the lowest ask price for a traded instrument.

“Market Depth” means the full range of prices in the market for a given traded instrument.

“Market scope” means the market depth for a given traded instrument viewable over a wide range of market prices as the market moves.

“Order entry tool” means a GUI designed to permit and/or facilitate electronic trading operations, such as Rotator™.

“Outside market” means the worst (lowest) bid price and worst (highest) ask price for a traded instrument.

“Selected historical market” (i.e., the “snapshot”) means the inside market and the outside market at a given historical time chosen by the trader for a given traded instrument.

“Traded instrument” means any article of commerce which may be traded, including but not limited to stocks, bonds, commodities and derivatives (futures and options).

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

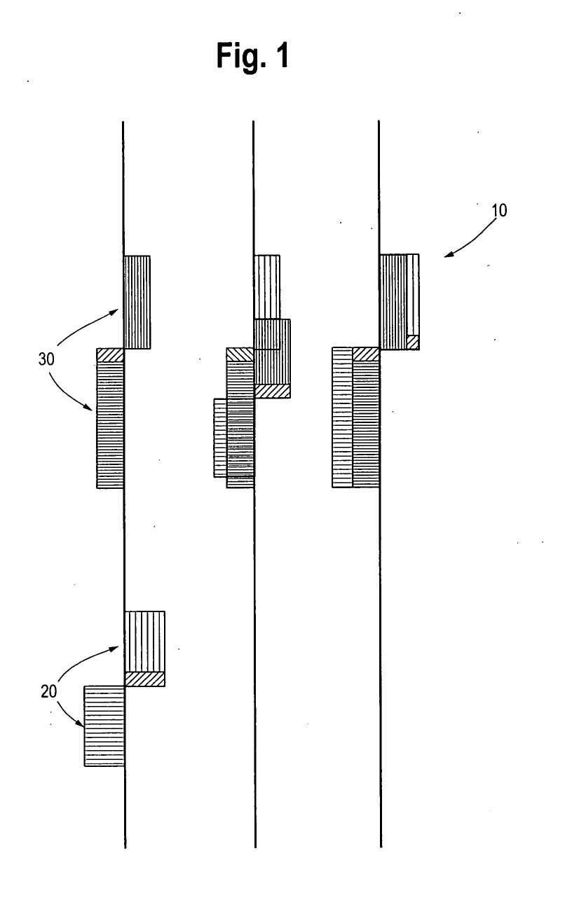

Referring now to FIG. 1, a particularly preferred embodiment of the present invention is shown there, referenced generally as reference numeral 10, and known as Market Scope™. Market Scope™ is designed for use with order entry tools such as Rotator™, as shown in FIG. 3 and more specifically discussed below.

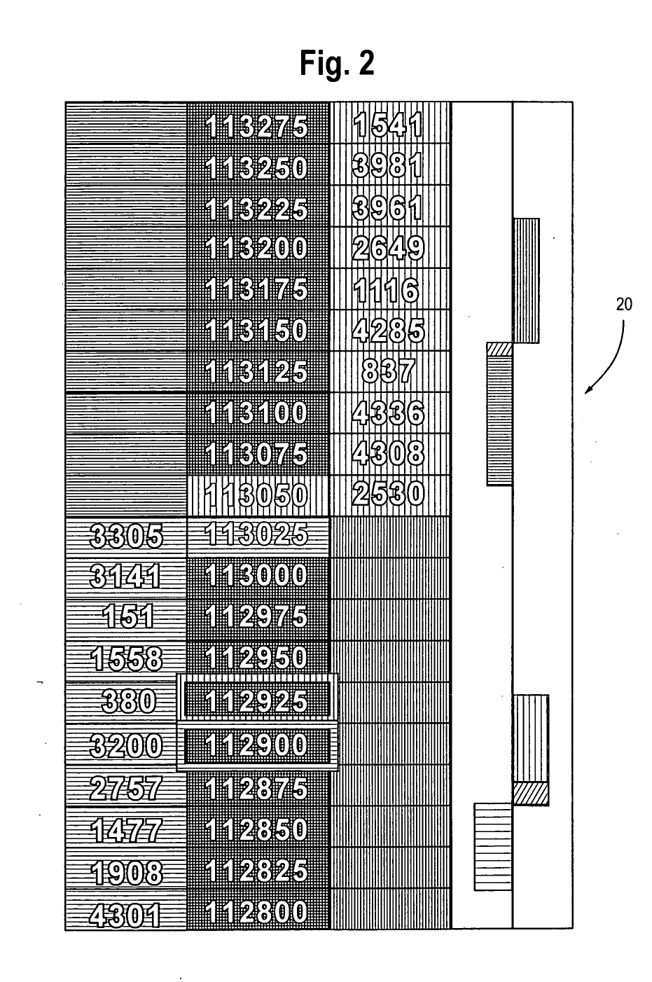

Referring back to FIG. 1, wider transparent bars 20 represent the last “snapshot” taken by the trader of the market, i.e., a selected historical market. Narrower solid bars 30 represent the current market. Red bars (coded for color), for example, may represent the range of offers while blue bars may represent the range of bids. A yellow bar may be used to represent the last traded price. Three examples are shown in FIG. 1, with various overlaps between the selected historical and current markets. FIG. 2 is an alternative embodiment of Market Scope™ using single, tri-colored bars to show current and past market conditions.

Referring now to FIG. 3, Market Scope™ 10 may be used in conjunction with an order entry tool 20 such as Rotator™. The use of Rotator™ is thoroughly discussed in the Rotator™ patent whose disclosure is incorporated in its entirety herein. Thus, color-coded price volume column 30 (e.g., colored grey), bid volume column 40 (e.g., colored blue) and offer volume column 50 (e.g., colored red) may be provided, and updated dynamically on a real-time basis as the market changes for the traded instrument.

Mouse cursor 60 may be used to consummate a trade. In a particularly preferred embodiment, the previous best bid and offer, before scrolling commences, may be highlighted with borders 70 (e.g., “112925” may be provided with a red border), 80 (e.g., “112900” may be provided with a blue border), as shown in FIG. 3). This provides the trader with a spatial perspective of how far the market has moved.

Of course, various alternative embodiments still in keeping with the principles of the present invention may be used. As one example, the wider transparent bars 20 could represent the current market, while the narrower solid bars 30 represent the selected historical market. Another variation, shown in FIG. 2, is that instead of left bars showing bids and right bars showing offers, a single, bi-colored or tri-colored bar could be used to show both. Other such variations will no doubt be apparent to those of ordinary skill in the art.

The above description is not intended to limit the meaning of the words used in the following claims that define the invention. Other systems, methods, features, and advantages of the present invention will be, or will become, apparent to one having ordinary skill in the art upon examination of the foregoing drawings, written description and claims, and persons of ordinary skill in the art will understand that a variety of other designs still falling within the scope of the following claims may be envisioned and used. It is contemplated that these or other future modifications in structure, function or result will exist that are not substantial changes and that all such insubstantial changes in what is claimed are intended to be covered by the claims.

I claim:

1. A GUI display presenting market scope for a traded instrument, comprising:
a graphical display showing and differentiating the current market from at least one selected historical market for the traded instrument.

2. The GUI display of claim 1, wherein the graphical display separately denotes a last traded price.

3. The GUI display of claim 1, further comprising an order entry tool aligned with the market scope.

4. The GUI display of claim 1, wherein the graphical display comprises histograms color-coded to show ranges of offers and bids.

5. The GUI display of claim 3, wherein the order entry tool comprises a plurality of bids, offers and aligned price entries for the traded instrument.

6. The GUI display of claim 4, wherein the histograms are separately color-coded to display a last traded price.

7. A method of electronically trading an instrument using a GUI display presenting market scope for the traded instrument, comprising the steps of:
providing a graphical display showing and differentiating the current market from at least one selected historical market;
providing an order entry tool aligned with the graphical display, the order entry tool comprising a plurality of bids, offers and aligned price entries for the traded instrument; and
using the order entry tool to place a trade order for the traded instrument.

8. The method of claim 7, wherein the graphical display separately denotes a last traded price.

9. The method of claim 7, wherein the graphical display comprises histograms color-coded to show ranges of offers and bids.

10. A system for placing a trade order for a traded instrument on an electronic exchange having an inside market with a highest bid price and a lowest ask price, the system comprising:
a graphical user interface for displaying market depth of the traded instrument, through a dynamic display of a plurality of bids and a plurality of asks in the market for the traded instrument, including the bid and ask quantities of the traded instrument, aligned with a display of prices for the traded instrument, and for displaying an order entry region aligned with the display of prices, comprising a plurality of areas for receiving commands to send trade orders, each area corresponding to a price of the display of prices;
wherein the graphical user interface also shows and differentiates the current market from at least one selected historical market;
a user input device for positioning a pointer over an area in the order entry region; and
a trade order sending component for receiving a command as a result of a selection of the area in the order entry region by a single action of the user input device with a pointer of the user input device positioned over the area, to set a plurality of additional parameters for the trade order and send the trade order to the electronic exchange.
